(19) United States
(12) Patent Application Publication
(10) Pub. No.: US 2026/0213539 A1
(43) Pub. Date: Jul. 23, 2026

(54) AUXILIARY POWER TAP ASSEMBLIES FOR BATTERY ENERGY STORAGE SYSTEMS AND BATTERY ENERGY STORAGE SYSTEMS AND METHODS INCLUDING SAME

(71) Applicant: TE Connectivity Solutions GmbH, Schaffhausen (CH)

(72) Inventor: Praveen Margana, Fuquay-Varina, NC (US)

(21) Appl. No.: 19/032,779

(22) Filed: Jan. 21, 2025

(51) Int. Cl. H02J 3/32; H01H 85/02; H01R 4/2433; H01R 4/2475

(52) U.S. Cl. CPC H02J 3/32; H01H 85/0241; H01R 4/2433; H01R 4/2475

(57) ABSTRACT

A battery energy storage system (BESS) for connection to a power supply includes a BESS unit and an auxiliary power supply network. The BESS unit includes an energy storage battery and an auxiliary power unit including an auxiliary power connection terminal. The auxiliary power supply network includes an auxiliary power trunk cable electrically connected to the power supply, and an auxiliary power connection system including an auxiliary power tap assembly. The auxiliary power tap assembly includes a tap cable, an insulation piercing connector (IPC), and a fuse. The IPC is engaged with the auxiliary power trunk cable to electrically couple the tap cable to the auxiliary power trunk cable. The tap cable electrically connects the auxiliary power trunk cable to the auxiliary power connection terminal. The fuse is connected to the tap cable electrically in-line between the IPC and the auxiliary power connection terminal.

### FIELD

The present invention relates to battery energy storage systems and methods for forming battery energy storage systems and, more particularly, to auxiliary power connections in battery energy storage systems.

### BACKGROUND

Auxiliary power in battery energy storage systems (BESS) containers is typically provided by a dedicated 480V AC feed from the secondary of an auxiliary power transformer, which receives its primary power from a substation. The cable in this traditional solution is routed underground from the auxiliary power transformer to a switchboard and/or panelboard, which has circuit breakers routing additional (smaller) cables to an array of BESS containers (one circuit breaker per container). The cables terminate in each BESS container.

### SUMMARY

According to some embodiments, a battery energy storage system (BESS) for connection to a power supply includes a BESS unit and an auxiliary power supply network. The BESS unit includes an energy storage battery and an auxiliary power unit including an auxiliary power connection terminal. The auxiliary power supply network includes an auxiliary power trunk cable electrically connected to the power supply, and an auxiliary power connection system including an auxiliary power tap assembly. The auxiliary power tap assembly includes a tap cable, an insulation piercing connector (IPC), and a fuse. The IPC is engaged with the auxiliary power trunk cable to electrically couple the tap cable to the auxiliary power trunk cable. The tap cable electrically connects the auxiliary power trunk cable to the auxiliary power connection terminal. The fuse is connected to the tap cable electrically in-line between the IPC and the auxiliary power connection terminal.

According to some embodiments, a pre-assembled auxiliary power tap assembly for forming an auxiliary power supply network to provide auxiliary power from a power supply to a BESS unit of a battery energy storage system (BESS) includes: a tap cable including a tap cable conductor; an integral insulation piercing connector (IPC) engaged with the tap cable and electrically contacting the tap cable conductor; and an integral fuse folder connected in-line on the tap cable. The IPC is configured to engage an auxiliary power trunk cable to electrically couple the tap cable to the auxiliary power trunk cable. The tap cable is configured to electrically connect the auxiliary power trunk cable to an auxiliary power connection terminal of the BESS unit.

### BRIEF DESCRIPTION OF THE DRAWINGS

FIG. 1 is a schematic view of a BESS according to some embodiments.

FIG. 2 is a schematic view of the BESS of FIG. 1.

FIG. 3 is a schematic view of the BESS of FIG. 1.

FIG. 4 is a fragmentary, perspective view of an auxiliary power supply network forming a part of the BESS of FIG. 1.

FIG. 5 is a fragmentary, perspective view of an example BESS unit forming a part of the BESS of FIG. 1.

FIG. 6 is a perspective view of an insulation piercing connector (IPC) forming a part of the BESS of FIG. 1.

FIG. 7 is an exploded, perspective view of the IPC of FIG. 6.

FIG. 8 is a perspective view of a cable connection including the IPC of FIG. 6 and also a sealant-filled IPC enclosure.

FIG. 9 is cross-sectional view of the cable connection of FIG. 9.

FIG. 10 is a perspective view of a pre-assembled auxiliary power connection assembly according to some embodiments.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

As used herein, “monolithic” means an object that is a single, unitary piece formed or composed of a material without joints or seams.

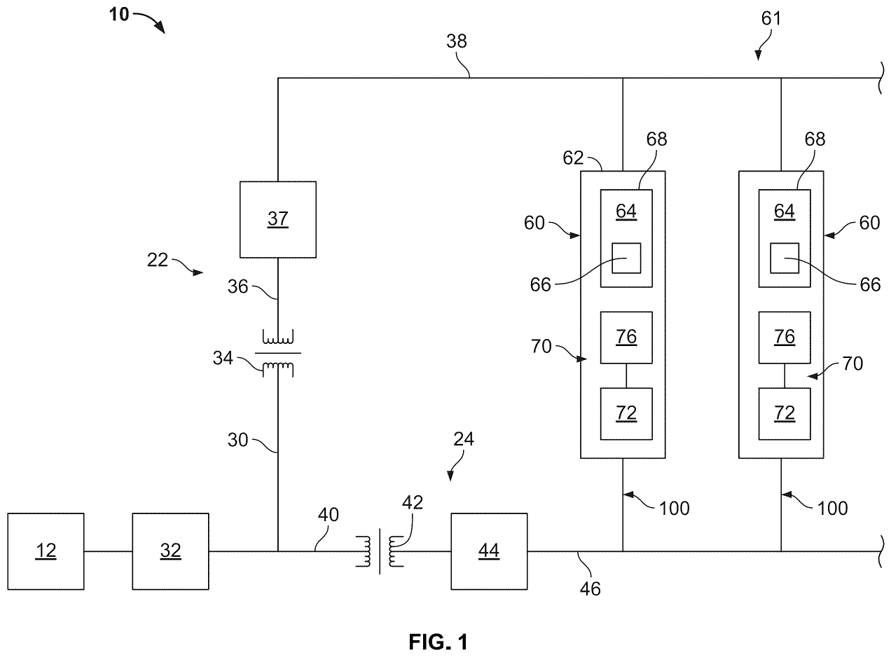

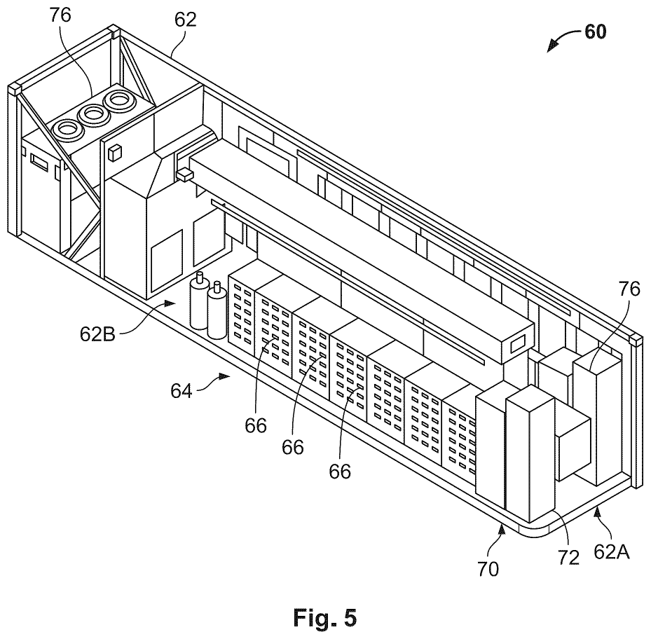

With reference to FIGS. 1-9, a battery energy storage system (BESS) 10 according to some embodiments of the present technology is shown therein. The BESS 10 may be used to collect, store and supply electrical power. The illustrative BESS 10 includes a primary power supply 12, a BESS unit array 61, a main power network 22, and an auxiliary power supply network 24. The BESS unit array 61 includes a plurality of BESS units 60. Each BESS unit 60 includes a main energy storage system 64 (including batteries 66; FIGS. 1 and 5) and an auxiliary system 70. Each auxiliary system 70 includes an auxiliary power unit 72 and one or more auxiliary equipment or loads 76. The auxiliary power supply network 24 includes a plurality of auxiliary power connection systems 100 (e.g., one for each BESS unit 60) according to embodiments of the technology.

In some embodiments, the primary power supply 12 is a station or node of a utility electrical power generation and distribution grid. In some embodiments, the primary power supply 12 is an electrical power distribution substation.

The main power network 22 includes a medium voltage (MV) transmission cable 30, primary switchgear 32, a main medium voltage-to-low voltage (MV/LV) transformer 34, a main AC power cable 36, a main power conversion system 37 (e.g., including an AC-to-DC converter), and a main DC power bus 38. The main energy storage system 64 of each BESS 60 is electrically connected to the main DC power bus 38 to charge the batteries 66 of the BESS 60.

It will be appreciated that embodiments of the present technology may be employed in BESSs of other types and designs. For example, whereas the batteries of the BESS units 60 in the illustrative example are charged with power from a utility transmission grid, in other embodiments the batteries 66 are instead charged with power from a different type of power source. For example, such other type of power source may be a photovoltaic cell or array, a wind power generator, a geothermal power generator, or any other suitable power generator or source. It will be further appreciated that the main power network 22 is not limited to the arrangement or construction illustrated and may be revised for different types of power supplies or needs.

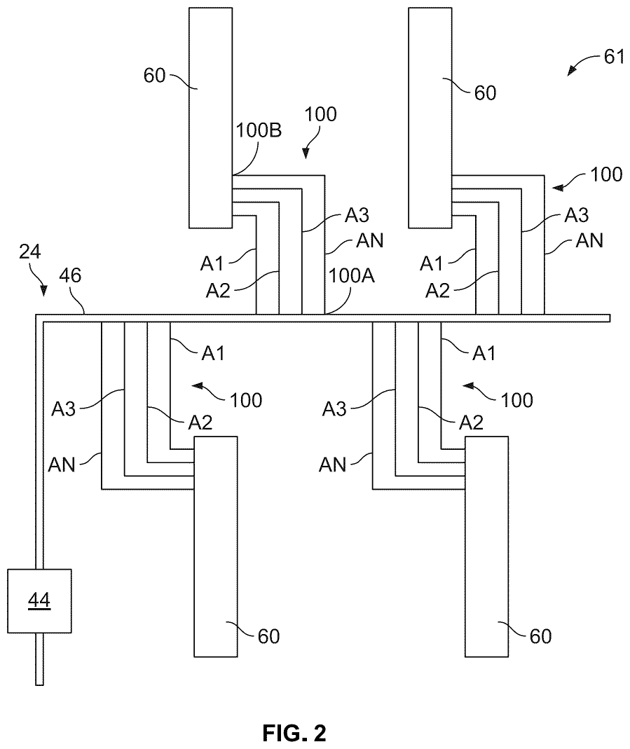

The auxiliary power supply network 24 includes an auxiliary power branch cable 40, an auxiliary MV/LV transformer 42, an auxiliary switchboard 44, an auxiliary power trunk cable set or bundle 46, an auxiliary cable tray or trays 48, and the auxiliary power connecting systems 100. The auxiliary power trunk cable set 46 includes three auxiliary power phase cables L1, L2 and L3 each connected to a respective electrical power phase from the power supply 12, and a neutral cable LN. The auxiliary power unit 72 of each BESS unit 60 is electrically connected to the auxiliary power trunk cable set 46 by a respective one of the auxiliary power connection systems 100, as illustrated in FIGS. 2-4.

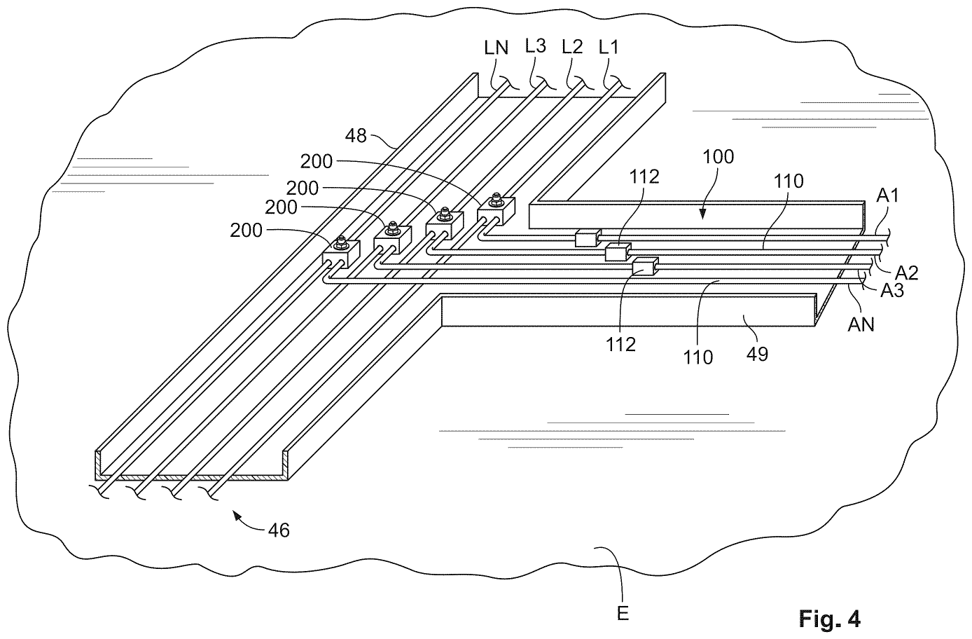

In some embodiments, the auxiliary power supply network 24 includes above-ground cable trays 48 (FIG. 4) through which the trunk cables L1, L2, L3, LN are routed between or along the BESS units. In some embodiments, the auxiliary power supply network 24 includes above-ground cable trays 49 through which the auxiliary power connecting systems 100 are routed from the trunk cables L1, L2, L3, LN to the respective BESS units 60 (see FIG. 4). The cable trays 48, 49 may be raised above the ground E or may direct on the ground E.

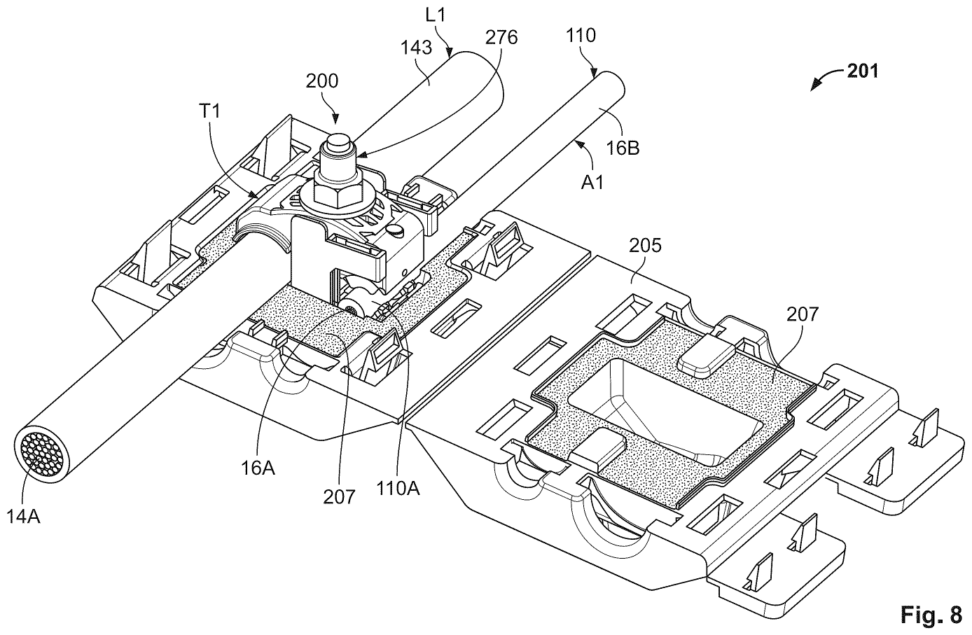

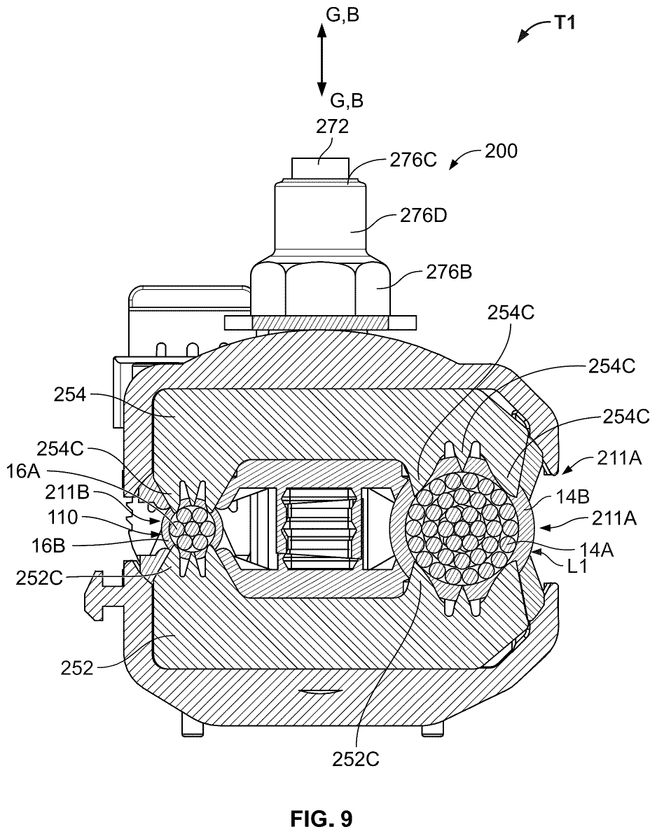

Each of the trunk cables L1, L2, L3, LN may have substantially the same construction and an example one L1 of the trunk cables is shown in FIGS. 8 and 9. With reference to FIGS. 8 and 9, the trunk cable L1 includes a metal electrical conductor 14A surrounded by an electrical insulation layer 14B. The trunk cable L1 may be generally cylindrical. The conductor 14A may be formed of multiple strands (e.g., parallel or twisted strands) as illustrated in the figures or may be solid cylindrical conductors (solid wire). Suitable materials for the conductor 14A may include aluminum or copper. The insulation layer 14B may be formed of a polymeric material such as PVC, polypropylene, polyethylene, or cross-linked polyethylene.

Each BESS unit 60 (FIG. 5) includes a container 62, a respective integral main energy storage system 64, and a respective integral auxiliary system 70. The container 62 may define a battery compartment 62B and an auxiliary compartment 62A. The container 62 may be a sturdy metal enclosure including a door or portal for operator access, for example. The container 62 may be a mobile trailer.

The energy storage batteries 66 of each BESS unit 60 may be disposed in the battery compartment 62B. The batteries 66 may be connected to the DC power bus 38 via main connector terminals 68 (FIG. 1). Each BESS unit 60 may include DC power distribution terminals to distribute power from its batteries 66.

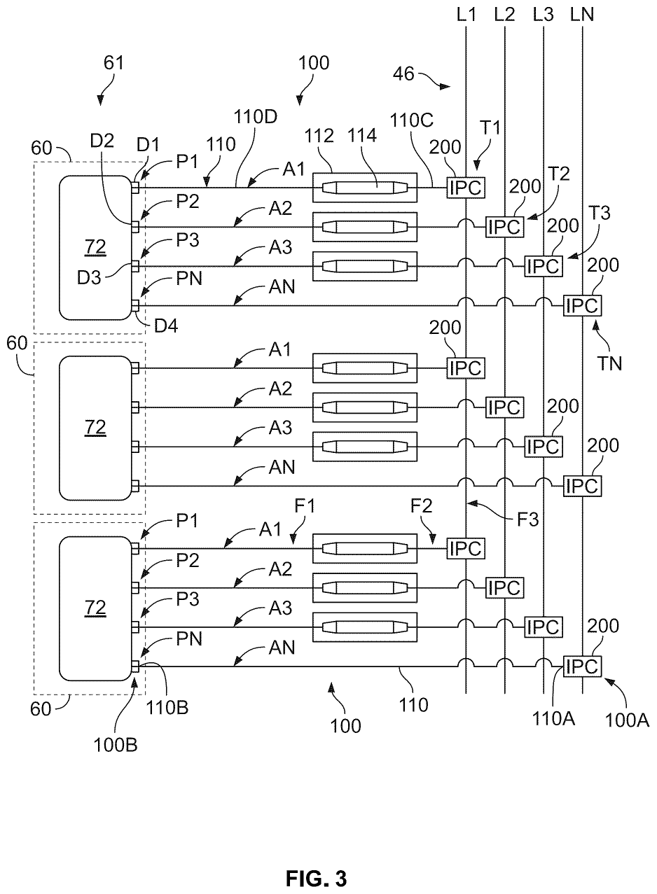

The auxiliary system 70 of each BESS unit 60 includes an auxiliary power unit 72 and one or more auxiliary equipment or loads 76, each or which may be disposed in the auxiliary compartment 62A or elsewhere in the BESS unit 60. The auxiliary power unit 72 includes four auxiliary power connection terminals D1, D2, D3, DN (FIG. 3).

The auxiliary equipment or loads 76 may be any suitable auxiliary systems, equipment or loads operable to provide auxiliary functions to the BESS unit 60. The auxiliary equipment or loads 76 may include one or more of the following but are not limited thereto: a control circuit; temperature control equipment (e.g., a fan or chiller); battery monitoring equipment (e.g., configured to monitor a temperature or state of charge of the batteries 66); and fire suppression equipment.

Each auxiliary power connection system 100 includes four auxiliary power wiring harnesses or auxiliary power tap assemblies A1, A2, A3 and AN corresponding to the auxiliary power trunk cables L1, L2, L3 and LN, respectively. Each auxiliary power tap assembly A1, A2, A3, AN includes a tap cable 110, a fuse holder 112, a fuse 114, and an IPC system 201. Each auxiliary power tap assembly A1, A2, A3, AN has opposed ends 100A, 100B. Each IPC system 201 (described in more detail below) includes an insulation piercing connector (IPC) 200 and an IPC cover or enclosure 205. In some embodiments, the IPC enclosure 205 is filled with a sealant 207. In some embodiments, the IPC enclosure 205 and the sealant 207 are omitted.

Each tap cable 110 has opposed ends 110A, 110B. The tap cables 110 of the power tap assemblies A1, A2, A3 each include a fuse holder 112, operatively holding a fuse 114, mounted electrically inline between the cable ends 110A, 110B. The tap cables 110 of the power tap assemblies A1, A2, A3 each include a first tap cable section 110C extending from the end 110A to the fuse holder 112, and a second tap cable section 110D extending from the fuse holder 112 to the end 110B (FIG. 3).

Each of the tap cables 110 may have substantially the same construction and an example one of the tap cables 110 is shown in FIGS. 8 and 9. With reference to FIGS. 8 and 9, the tap cable 110 includes a metal electrical conductor 16A surrounded by an electrical insulation layer 16B. The tap cable 110 may be generally cylindrical. The conductor 16A may be formed of multiple strands (e.g., parallel or twisted strands) as illustrated in the figures or may be solid cylindrical conductors (solid wire). Multi-strand conductors may be easier to handle with better bending characteristics. Suitable materials for the conductor 16A may include aluminum or copper. The insulation layer 16B may be formed of a polymeric material such as PVC, polypropylene, polyethylene, or cross-linked polyethylene.

As illustrated in FIG. 3, each of the auxiliary power tap assemblies A1, A2, A3, and AN is connected at one end 100A, by a respective IPC 200, to a corresponding respective one of the trunk cables L1, L2, L3, and LN to form a respective trunk cable connection T1, T2, T3, and TN. Additionally, each of the auxiliary power tap assemblies A1, A2, A3, and AN is connected at its other end 100B to a corresponding respective one of the auxiliary power connection terminals D1, D2, D3, and DN of the BESS unit 60 to form a respective BESS unit connection P1, P2, P3, and PN.

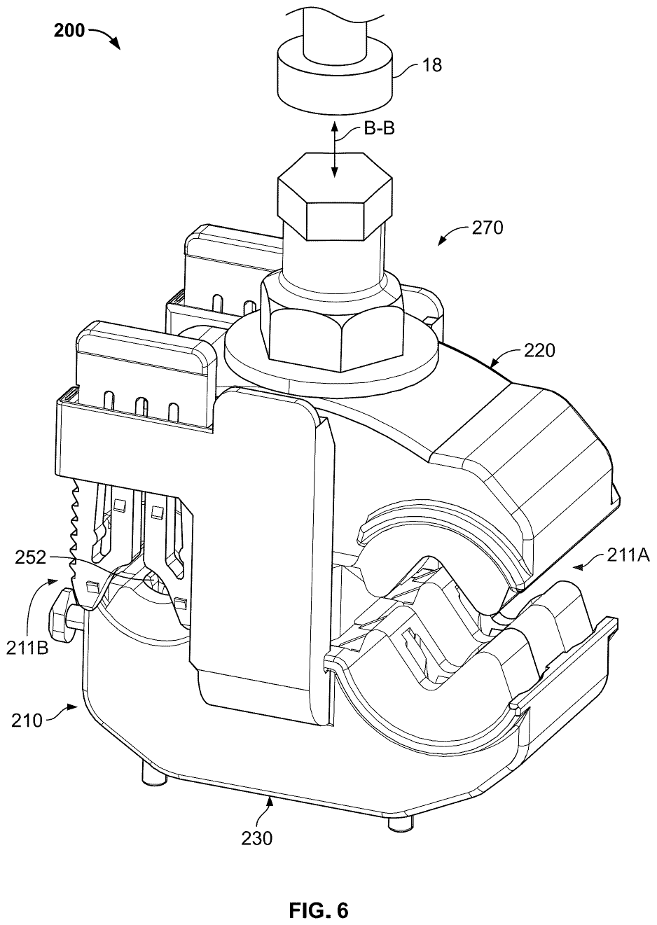

With reference to FIGS. 6-9, an example IPC 200 according to some embodiments is shown therein. In other embodiments, a connector system and method as described herein may include a different type of IPC electrical connector in place of an IPC connector 200.

FIGS. 8 and 9 show the IPC 200 of the auxiliary power tap assembly A1 connecting the tap cable 110 of auxiliary power tap assembly A1 to the trunk cable L1. It will be appreciated that the IPCs 200 of the auxiliary power tap assemblies A2, A3, and AN connect the tap cables 110 of auxiliary power tap assemblies A2, A3, and AN to the trunk cables L2, L3, and LN, respectively, in the same manner.

The IPC 200 mechanically and electrically couples the cable L1 with the cable 110 of the auxiliary power tap assembly A1 and thereby forms the connection T1. When installed on the cables L1, 110, the connector 200 provides electrical connectivity between the conductor 14A and the conductor 16A. This connection is used to feed electrical power from the trunk cable conductor 14A to the tap cable conductor 16A and thereby from the trunk cable L1 to the auxiliary power connection terminal D1 through the tap cable 110 and the fuse 114.

The IPC 200 may be constructed and operated as disclosed in U.S. Pat. No. 11,431,114 to Newman, the disclosure of which is incorporated herein by reference, for example. The IPC 200 may be a GS-IPC-500 connector, available from TE Connectivity, for example.

Generally, and as described in more detail below, a driver 18 (FIG. 6) may be used to secure the connector 200 on the cables L1, 110. The enclosure 205 (FIG. 8) may be installed on and surround the connection T1 to form an enclosed connection assembly.

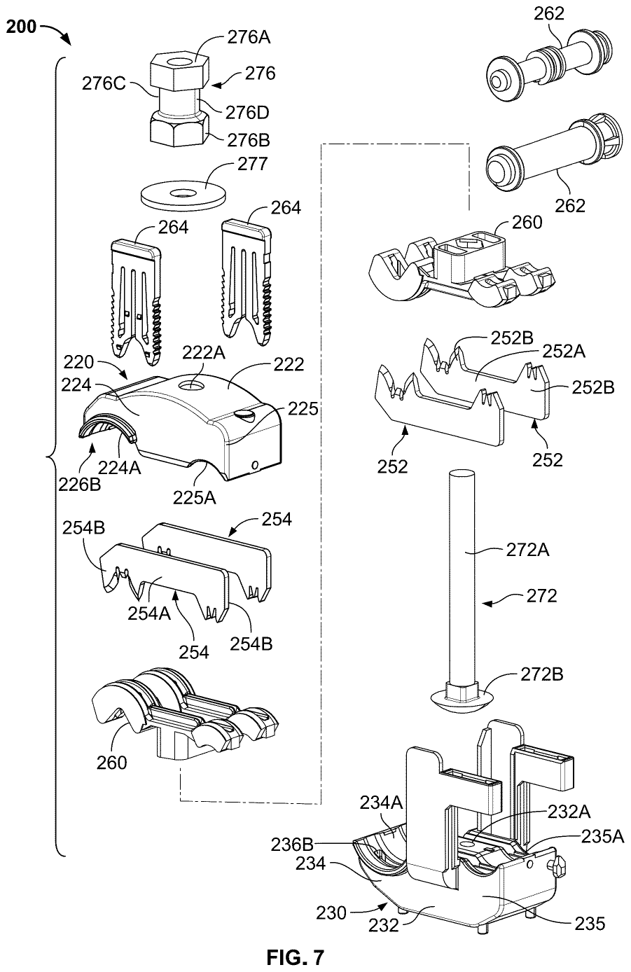

With reference to FIGS. 6 and 7, the IPC 200 includes a connector body assembly 210, a first pair of blade members 252 (hereinafter, the “lower blade members”), a second pair of blade members 254 (hereinafter, the “upper blade members”), seal members 260, cable end caps 262, end cap retainers 264 and a clamping or compression mechanism 270. The connector 200 has a longitudinal axis G-G.

The connector body assembly 210 includes a first or upper body member 220, and a second or lower body member 230.

The upper body member 220 includes a support portion 222 and a pair of laterally opposed legs or jaw portions 224, 225 extending laterally from the support portion 222 with respect to the connector axis G-G. The support portion 222 includes a bore 222A. The jaw portion 224 includes a cable groove or seat 224A. The jaw portion 225 includes a cable groove or seat 225A. The jaw portion 224 further includes, in the cable seat 224A, a pair of blade slots or seats 224B. The jaw portion 225 further includes, in the cable seat 225A, a pair of blade slots or seats 226B.

The lower body member 230 includes a support portion 232 and a pair of laterally opposed legs or jaw portions 234, 235 extending laterally from the support portion 232 with respect to the connector axis G-G. The support portion 232 includes a bore 232A. The jaw portion 234 includes a cable groove or seat 234A. The jaw portion 235 includes a cable groove or seat 235A. The jaw portion 234 further includes, in the cable seat 234A, a pair of blade slots or seats 234B. The jaw portion 235 further includes, in the cable seat 235A, a pair of blade slots or seats 236B.

The jaw portion 224 and the jaw portion 234 define a first or main side cable receiving slot 211A therebetween. The jaw portion 225 and the jaw portion 235 define a second or tap side cable receiving slot 211B therebetween.

The body members 220, 230 may be formed of any suitable material. According to some embodiments, the body members 220, 230 are formed of a polymeric material.

The compression mechanism 270 includes a bolt 272, and a torque control member in the form of a nut 276. A washer 277 may be provided between the nut 276 and the upper body member 220. However, other types of compression mechanisms may be used for the compression mechanism 270. For example, the compression mechanism may include an inclined surface device operable to provide mechanical advantage, for example.

The bolt 272 may be a carriage bolt and includes a threaded shank 272A, and a head 272B.

In some embodiments and as shown, the nut 276 is a shear nut including a shear head 276A, a base portion 276B, a shear or breakaway section 276C coupling the portions 276A and 276B, and a tubular, internally threaded connecting section 276D extending from the base portion 276B to the breakaway section 276C.

The bolt 272 extends through the bores 222A, 232A and is axially constrained by the bolt head 272B and the body member 230. The nut 276 is rotatably mounted on the bolt 272 and is axially constrained by the body member 220.

The axial spacing distance between the cable seats 224A, 234A and 225A, 235A can be varied. The body member 220 can slide up and down the bolt 272 relative to the lower body member 230 another along a slide axis B-B. Accordingly, the heights of the slots 211A, 211B can be independently varied.

In use, the shear head 276A of the nut 276 is engaged by a driver and forcibly rotated thereby. The shear head 276A may be faceted or otherwise shaped to mate with the tool. The nut 276 is thereby rotated relative to the axially and bolt 272, which may be rotationally constrained by a tool or an anti-rotation feature or mechanism of the connector 200. This causes the bolt 272 to translate up through the nut 276, which slides or translates the body portions 220 and 230 together (in respective converging directions) along the slide axis B-B. The shear head 276A will shear off from the base portion 276B at the breakaway section 276C when subjected to a prescribed torque. The base portion 276B may be faceted or otherwise configured to mate with a tool to enable loosening of the nut 276 to permit removal of the connector 200 from the cables.

Each lower blade member 252 is mounted in one of the blade slots 236B for movement with the upper body member 230. Each lower blade member 252 includes a body or base 252A having laterally opposed ends. Each end is provided with an integral cable engagement or insulation piercing feature 252B. Each insulation piercing feature 252B includes a plurality of serrations or teeth 252C separated by slots and having terminal points. The points of the teeth 252C may collectively lie on an arc generally corresponding to the profile of the arcuate outer surface of the corresponding cable conductor 14A, 16A.

Each upper blade member 254 is mounted in one of the blade slots 226B for movement with the upper body member 220. Each main blade member 254 includes a body or base 254A having axially opposed ends. Each end is provided with an integral cable engagement or insulation piercing feature 254B. Each insulation piercing feature 254B includes a plurality of serrations or teeth 254C separated by slots and having terminal points. The points of the teeth 254C may collectively lie on an arc generally corresponding to the profile of the arcuate outer surface of the corresponding cable conductor 14A, 16A.

The blade members 252, 254 are affixed in their respective blade seats such that the teeth 254C of the blade members 254 face the teeth 252C of the blade members 252.

The blade members 252, 254 may be formed of any suitable electrically conductive material. According to some embodiments, the blade members 252, 254 are formed of metal. According to some embodiments, the blade members 252, 254 are formed of aluminum, aluminum alloy, or copper and may be galvanized. The blade members 252, 254 may be formed using any suitable technique. According to some embodiments, each blade members 252, 254 is monolithic and unitarily formed.

The sealant-filled cover or enclosure 205 may operate to seal about and protect the connection T1. The sealant-filled cover or enclosure 205 may be constructed and operated as disclosed in U.S. Pat. No. 11,431,114 to Newman, the disclosure of which is incorporated herein by reference, for example.

The sealant 207 may be any suitable sealant. According to some embodiments, the sealant 207 is a sealant as disclosed in U.S. Pat. No. 11,431,114 to Newman. According to some embodiments, the sealant 207 is a gel sealant. As used herein, “gel” refers to the category of materials which are solids extended by a fluid extender. According to some embodiments, the sealant 207 is a gel sealant as disclosed in U.S. Pat. No. 11,431,114. According to some embodiments, the sealant 207 is a self-healing or self-amalgamating gel. According to some embodiments, the sealant 207 is a non-gel sealant. For example, the sealant 207 may be silicone grease or hydrocarbon-based grease.

The IPC 200 can be installed as follows to form the connection T1. It will be appreciated that this description applies likewise to installation of the IPCs 200 of the other auxiliary power tap assemblies A2, A3, AN on the cables L2, L3, LN to form the connections T2, T3, T4.

If necessary, the compression mechanism 270 is loosened or opened to permit the jaw portions 224, 234 and 225, 235 (and thereby the blade members 252, 254) to be separated. The cable L1 (with the insulation layer 14B covering the conductor 14A) is inserted in or between the cable grooves 224A, 234A and the cable 110 (with the insulation layer 16B covering the conductor 16A) is inserted in or between the cable grooves 225A, 235A. The cables L1, 110 can be axially or laterally inserted into the slots defined between the jaws.

The nut 276 is then driven to compress the compression mechanism 270 along the slide axis B-B and thereby drive the jaws 224, 234 and 225, 235 together along a clamping axis parallel to the slide axis B-B. The nut 276 is driven until a prescribed torque is applied. The shear nut 276 is driven via the shear head 276A until a prescribed torque is applied, whereupon the shear head 276A will break off at the shear section 276C, thereby helping to ensure that the proper load is applied to the blade members 252, 254, 256.

As a result, the insulation piercing features 252B, 254B of the opposed pairs of the blade members 252, 254 are driven to converge on and capture the cables L1, 110 therebetween. More particularly, the teeth 252C, 254C of each blade member 252, 254 are forced through the insulation layers 14B, 16B and into mechanical and electrical contact with the conductors 14A, 16A. The teeth 252C, 254C embed in the insulation layers 14B, 16B and make electrical and mechanical contact or engagement with the conductors 14A, 16A. In the foregoing manner, the IPC 200 is operatively connected to the cables L1, 110 and the conductors 14A, 16A are electrically connected to one another without stripping the insulation layers 14B, 16B.

According to some embodiments, the teeth 252C, 254C embed in the conductors 14A, 16A. According to some embodiments, the teeth 252C, 254C embed into the conductors 14A, 16A a distance of at least about 0.5 mm.

In the foregoing manner, the connection T1 is formed. The blade members 252, 254 provide electrical continuity (i.e., a path for electrical current flow) between the conductors 14A, 16A of the cables L1, 110. The connector 200 mechanically secures the cables L1, 110 relative to one another.

Once the connection T1 has been constructed as described above, the sealant-filled enclosure 205 is installed on the connection T1 and the cables L1, 110.

The conductor 14A and the conductor 16A may be of the same wire gauge or different wire gauge in different applications and the connector 200 is adapted to accommodate a range of wire gauges for the conductor 14A and the conductor 16A. In some embodiments, the conductor 14A has a larger cross-sectional diameter than the conductor 16A.

When the sealant 207 is a gel, the cables L1, 110 and the enclosure 205 may apply a compressive force to the sealant 207 as the enclosure 205 is transitioned from the open position to the closed position. The gel may thereby be elongated and be generally deformed and substantially conform to the outer surfaces of the connector 200, the cables L1, 110 and to the inner surface of the enclosure 205. Some shearing of the gel may occur as well. At least some of the gel deformation may be elastic. The restoring force in the gel resulting from this elastic deformation generally causes the gel to operate as a spring exerting an outward force between the enclosure 205 and the connector 200 and the cables L1, 110.

As discussed above and illustrated in FIG. 3, the auxiliary power unit 72 of each BESS unit 60 is electrically connected to the auxiliary power trunk cable set 46 by a respective one of the auxiliary power connection systems 100. More particularly and with reference to FIG. 3, the auxiliary power terminals D1, D2, D3, and DN of each auxiliary power unit 72 are electrically connected to the trunk cables L1, L2, L3, and LN, respectively, by the auxiliary power tap assemblies A1, A2, A3, and AN, respectively, of the auxiliary power connection system 100 associated with the auxiliary power unit 72.

In some embodiments, each auxiliary power tap assemblies A1, A2, A3, AN is assembled onsite. The fuse holder 112 and fuse 114 are installed inline in the tap cable 110. The tap cable end 110A is connected to the corresponding trunk cable L1, L2, L3, LN using the IPC 200 as described above. The other tap cable end 110B is connected to the auxiliary power unit 72 at the corresponding auxiliary power terminals D1, D2, D3, and DN. If necessary, the tap cable end 110B may be terminated with an appropriate connector for mating with the auxiliary power terminal D1, D2, D3, DN. In this manner, the tap cable 110, the fuse holder 112, the fuse 114, and the IPC 200 are assembled as an auxiliary power wiring harness. According to some embodiments, the tap cable 110, the fuse holder 112, and the IPC 200 are pre-configured or packaged as a matched kit.

In other embodiments, the tap cable 110 and the fuse holder 112 of each auxiliary power tap assembly A1, A2, A3, AN are preassembled at a factory to form a pre-manufactured wiring harness that is provided to the customer or installer to complete the power tap assembly A1, A2, A3, AN with an IPC 200. The fuse 114 may be preassembled into the fuse holder 112.

In other embodiments, the tap cable 110, the fuse holder 112, and an IPC 200 of each auxiliary power tap assembly A1, A2, A3, AN are preassembled at a factory to form a pre-manufactured wiring harness that is provided to the customer or installer to connect to the trunk cable. The fuse 114 may be preassembled into the fuse holder 112. In this case, the IPC 200 may be modified or revised such that the IPC is pre-mounted on the tap cable 110 (i.e., electrically engaged with the conductor 16A and mechanically secured to the cable 110) so that it is not necessary for the installer to clamp the IPC onto the tap cable. In this case, the installer only needs to install the IPC on the trunk cable to complete the connection between the trunk cable L1, L2, L3, LN and the tap cable 110.

In some embodiments, multiple BESS units 60 are connected to the same or a common auxiliary power trunk cable set 46. In some embodiments, the auxiliary power trunk cable set 46 extends along a row of serially arranged BESS units 60 and, in some embodiments, along and between rows of BESS units 60 (e.g., as illustrated in FIG. 2). In some embodiments, the auxiliary power trunk cable set 46 is disposed in the cable tray 48 from proximate the switchboard 44 to the connections T1, T2, T3, TN. In some embodiments, each set of auxiliary tap cables 110 is disposed in cable tray 49 from proximate the trunk cable tray 48 to the BESS container 62. In some embodiments, the tap cables 110 and the cable tray 49 extend underneath the associated BESS container 62.

With reference to FIG. 3, it will be appreciated that each auxiliary power tap assembly A1, A2, A3, AN connects a respective electrical phase or neutral terminal D1, D2, D3, DN of the associated BESS unit 60 to the corresponding phase or neutral trunk cable L1, L2, L3, LN. The auxiliary power supply network 24 (including the auxiliary power connection system 100) thereby provides a three-phase power supply to the auxiliary system 70 of the BESS unit 60. This three-phase power supply serves to power the auxiliary equipment or loads 76.

With reference to FIG. 3, the auxiliary power supply network 24 can respond to electrical faults as follows.

In response to a fault occurring between the auxiliary power unit 72 and the fuse 114 (location F1 the fuse 114 will open. By contrast, in a conventional panelboard-based system, either the feeder or main breaker will open due to miscoordination in the instantaneous region. This is a problem that is avoided with the auxiliary power supply network 24.

A fault is unlikely to occur between the fuse 114 and the connection T1, T2, T3, or TN (location F2). In the auxiliary power supply network 24, the upstream protection would trip, taking out all circuits downstream. In a conventional panelboard-based system, the main breaker would trip, also taking out all circuits downstream.

In response to a fault occurring between the connection T1, T2, T3, or TN and the auxiliary power switchboard 44 (location F3), the upstream protection will trip. In a conventional panelboard-based system, the upstream protection will trip.

Auxiliary power supply networks as disclosed herein can eliminate the need for panelboards and circuit breakers and underground cable conduit. This can lower project cost, reduce maintenance requirements, reduce installation time, and improve system reliability due to less nuisance tripping. Panelboards and underground conduit are expensive, time consuming to install, and require maintenance. AC panelboards for BESS auxiliary systems are a costly component that require a sizeable physical footprint along with preventative maintenance. Large power systems require owners to invest significant funding towards these panelboards as their quantity scales. Auxiliary power supply networks as disclosed herein can be much faster to install and can require no maintenance. In addition, the traditional design uses circuit breakers for system protection; these circuit breakers are typically thermal magnetic breakers that cause miscoordination between smaller feeder breakers and larger main breakers in the instantaneous region, resulting in the potential for nuisance tripping. The use of insulation piercing connectors and standard fuses removes this possibility of miscoordination, resulting in improved reliability of the power system.

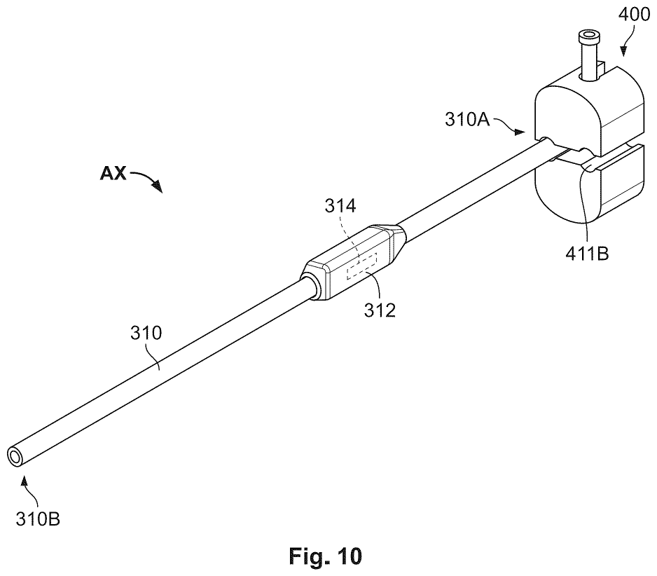

FIG. 10 shows an alternative embodiment wherein an auxiliary power tap assembly AX corresponding to any one of the auxiliary power tap assemblies A1, A2, A3 is provided as a pre-manufactured, pre-assembled wiring harness. That is, the auxiliary power tap assembly AX is pre-assembled at a factory and delivered as a pre-assembled wiring harness to the customer or installer. The auxiliary power tap assembly AX includes a tap cable 310 (having opposed ends 310A and 310B), an inline fuse holder 312, a fuse 314, and an IPC 400 corresponding to, operative in the same manner as, and constructed in the same manner as components 110, 110A, 110B, 112, 114, and 200, respectively, except as follows.

In the case of the auxiliary power tap assembly AX, the conductor of the tap cable 310 is pre-connected to the conductive elements of the IPC 400 (i.e., corresponding to the blades 252, 254). Accordingly, the IPC 400 is integrated with the tap cable 310 in the pre-manufactured auxiliary power tap assembly AX such that the IPC 400 is mechanically and electrically engaged with and connected to the tap cable 310 as delivered to the customer.

Auxiliary power tap assemblies AX can be used in place of the to construct an auxiliary power supply network 24 and BESS 10 as described herein auxiliary power tap assembly A1, A2, A3. A modified auxiliary power tap assemblies AX that omits the fuse holder 312 and fuse 314 can be used in place of the auxiliary power tap assembly AN.

In some embodiments, the conductors 16A of the tap cables 110, 310 are smaller in diameter than the conductors 14A of the trunk cables L1, L2, L3, LN to which they are connected by the IPCs 200, 400. In some embodiments, the trunk cable conductors 14A have a size in the range of from about 250 kcmil to 1000 kcmil and the tap cable conductors 16A have a size in the range of from about 10 AWG to 1/0 AWG.

In some embodiments, the power supplied from the auxiliary MV/LV transformer 42 to the auxiliary power unit 72 is a 480V AC power supply.

While auxiliary power connection assemblies 100 as disclosed herein include auxiliary power tap assemblies A1, A2, A3, AN for three phases and neutral, in other embodiments the auxiliary power connection assembly may not include an auxiliary power tap assembly as disclosed herein for connection to a neutral cable and/or may use a different number of phases depending on design need.

Many alterations and modifications may be made by those having ordinary skill in the art, given the benefit of present disclosure, without departing from the spirit and scope of the inventive concept(s). Therefore, it must be understood that the illustrated embodiments have been set forth only for the purposes of example, and that it should not be taken as limiting the inventive concept(s) as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive concept(s).

That which is claimed is:

1. A battery energy storage system (BESS) for connection to a power supply, the BESS comprising:
a BESS unit including:
an energy storage battery; and
an auxiliary power unit including an auxiliary power connection terminal; and
an auxiliary power supply network including:
an auxiliary power trunk cable electrically connected to the power supply; and
an auxiliary power connection system including an auxiliary power tap assembly including:
a tap cable;
an insulation piercing connector (IPC); and
a fuse;
wherein:
the IPC is engaged with the auxiliary power trunk cable to electrically couple the tap cable to the auxiliary power trunk cable;
the tap cable electrically connects the auxiliary power trunk cable to the auxiliary power connection terminal; and
the fuse is connected to the tap cable electrically in-line between the IPC and the auxiliary power connection terminal.

2. The BESS of claim 1 wherein the auxiliary power connection assembly includes a fuse holder mounted in the tap cable and holding the fuse.

3. The BESS of claim 1 wherein:
the auxiliary power connection system includes an above-ground cable tray; and
the tap cable is routed from the auxiliary power trunk cable to the BESS unit through the cable tray above ground.

4. The BESS of claim 1 including an above-ground cable tray, wherein the auxiliary power trunk cable is routed through the above-ground cable tray.

5. The BESS of claim 1 wherein the auxiliary power connection assembly includes an IPC enclosure surrounding the IPC to environmentally protect a connection between the IPC and the auxiliary power trunk cable.

6. The BESS of claim 1 wherein:
the power supply is a three-phase AC power supply;
the auxiliary power supply network includes a respective auxiliary power trunk cable for each of the three power supply phases;
the auxiliary power unit includes a respective auxiliary power connection terminal for each the three power supply phases;
the auxiliary power connection system includes three auxiliary power tap assemblies each electrically connecting a respective one of the three auxiliary power trunk cables to a corresponding one of the auxiliary power connection terminals; and
each of the three auxiliary power tap assemblies includes:
a tap cable;
an insulation piercing connector (IPC); and
a fuse;
wherein:
the IPC is engaged with the respective auxiliary power trunk cable to electrically couple the tap cable to the respective auxiliary power trunk cable;
the tap cable electrically connects the respective auxiliary power trunk cable to the respective auxiliary power connection terminal; and
the fuse is connected to the tap cable electrically in-line between the IPC and the respective auxiliary power connection terminal.

7. The BESS of claim 1 wherein:
the BESS includes a plurality of BESS units, each of the BESS units including:
an energy storage battery; and
an auxiliary power unit including an auxiliary power connection terminal; and
the auxiliary power connection system includes a plurality of auxiliary power tap assemblies electrically connecting the auxiliary power trunk cable to the auxiliary power connection terminal of a respective one of the plurality of BESS units;
wherein each of the auxiliary power tap assemblies includes:
a tap cable;
an insulation piercing connector (IPC); and
a fuse;
wherein:
the IPC is engaged with the auxiliary power trunk cable to electrically couple the tap cable to the auxiliary power trunk cable;
the tap cable electrically connects the auxiliary power trunk cable to a respective one of the auxiliary power connection terminals; and
the fuse is connected to the tap cable electrically in-line between the IPC and the respective auxiliary power connection terminal.

8. The BESS of claim 1 wherein the BESS unit includes an auxiliary system powered by the auxiliary power unit, the auxiliary system including at least one of: a control circuit; a temperature control equipment, battery monitoring equipment; and fire suppression equipment.

9. A method for providing auxiliary power from a power supply to a BESS unit of a battery energy storage system (BESS), the BESS unit including an energy storage battery and an auxiliary power unit including an auxiliary power connection terminal, the method comprising:
forming an auxiliary power supply network including:
an auxiliary power trunk cable electrically connected to the power supply; and
an auxiliary power connection system including an auxiliary power tap assembly including:
a tap cable;
an insulation piercing connector (IPC); and
a fuse;
wherein:
the IPC is engaged with the auxiliary power trunk cable to electrically couple the tap cable to the auxiliary power trunk cable;
the tap cable electrically connects the auxiliary power trunk cable to the auxiliary power connection terminal; and
the fuse is connected to the tap cable electrically in-line between the IPC and the auxiliary power connection terminal.

10. The method of claim 9 wherein the auxiliary power connection assembly includes a fuse holder mounted in the tap cable and holding the fuse.

11. The method of claim 9 wherein:
the auxiliary power connection system includes an above-ground cable tray; and
the method includes routing the tap cable from the auxiliary power trunk cable to the BESS unit through the above-ground cable tray.

12. The method of claim 9 including routing the auxiliary power trunk cable through an above-ground cable tray.

13. The method of claim 9 including mounting an IPC enclosure about the IPC to surround the IPC to environmentally protect a connection between the IPC and the auxiliary power trunk cable.

14. The method of claim 9 wherein:
the power supply is a three-phase AC power supply;
the auxiliary power supply network includes a respective auxiliary power trunk cable for each of the three power supply phases;
the auxiliary power unit includes a respective auxiliary power connection terminal for each the three power supply phases; and
forming an auxiliary power supply network includes forming the auxiliary power supply network such that:
the auxiliary power connection system includes three auxiliary power tap assemblies each electrically connecting a respective one of the three auxiliary power trunk cables to a corresponding one of the auxiliary power connection terminals;
wherein each of the auxiliary power tap assemblies includes:
a tap cable;
an insulation piercing connector (IPC); and
a fuse;
wherein:
the IPC is engaged with the respective auxiliary power trunk cable to electrically couple the tap cable to the respective auxiliary power trunk cable;
the tap cable electrically connects the respective auxiliary power trunk cable to the respective auxiliary power connection terminal; and
the fuse is connected to the tap cable electrically in-line between the IPC and the respective auxiliary power connection terminal.

15. The method of claim 9 wherein:
the BESS includes a plurality of BESS units, each of the BESS units including:
an energy storage battery; and
an auxiliary power unit including an auxiliary power connection terminal; and
forming an auxiliary power supply network includes forming the auxiliary power supply network such that:
the auxiliary power connection system includes a plurality of auxiliary power tap assemblies electrically connecting the auxiliary power trunk cable to the auxiliary power connection terminal of a respective one of the plurality of BESS units;
wherein each of the auxiliary power tap assemblies includes:
a tap cable;
an insulation piercing connector (IPC); and
a fuse;
wherein:
the IPC is engaged with the auxiliary power trunk cable to electrically couple the tap cable to the auxiliary power trunk cable;
the tap cable electrically connects the auxiliary power trunk cable to a respective one of the auxiliary power connection terminals; and
the fuse is connected to the tap cable electrically in-line between the IPC and the respective auxiliary power connection terminal.

16. The method of claim 9 wherein the BESS unit includes an auxiliary system powered by the auxiliary power unit, the auxiliary system including at least one of: a control circuit; a temperature control equipment, battery monitoring equipment; and fire suppression equipment.

17. The method of claim 9 wherein the auxiliary power tap assembly is pre-assembled in a factory.

18. A pre-assembled auxiliary power tap assembly for forming an auxiliary power supply network to provide auxiliary power from a power supply to a BESS unit of a battery energy storage system (BESS), the auxiliary power tap assembly comprising:
a tap cable including a tap cable conductor;
an integral insulation piercing connector (IPC) engaged with the tap cable and electrically contacting the tap cable conductor; and
an integral fuse folder connected in-line on the tap cable;
wherein:
the IPC is configured to engage an auxiliary power trunk cable to electrically couple the tap cable to the auxiliary power trunk cable; and
the tap cable is configured to electrically connect the auxiliary power trunk cable to an auxiliary power connection terminal of the BESS unit.
